(19) United States
(12) Patent Application Publication
(10) Pub. No.: US 2008/0174093 A1
(43) Pub. Date: Jul. 24, 2008

(54) Side airbag apparatus

(75) Inventor: Michio Inoue, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-Ken (JP)

(21) Appl. No.: 12/007,176

(22) Filed: Jan. 8, 2008

(30) Foreign Application Priority Data
Jan. 19, 2007 (JP) 2007-010362

(51) Int. Cl. B60R 21/237; B60R 21/207

(52) U.S. Cl. 280/730.2

(57) ABSTRACT

A side airbag apparatus has an inflator 31, an airbag 22, and a tether (partition portion) 26. The tether 26 partitions an internal space SI of the airbag 22 into a lumbar region protection chamber 27 inflated beside lumbar regions Pp of an occupant P and a thorax protection chamber 28 protecting a thorax Pt and an abdominal region Ps. The side airbag apparatus inflates the lumbar region protection chamber 27 at a higher internal pressure than the thorax protection chamber 28. In the side airbag apparatus, the tether 26 is disposed in the internal space SI so as to be inclined downward toward the front of the vehicle. The area corresponding to the lumbar region protection chamber 27 of the airbag 22 is folded along the inclination of the tether 26.

### BACKGROUND OF THE INVENTION

The present invention relates to a side airbag apparatus which inflates and deploys an airbag when an impact is applied to a vehicle from a side and reduces the impact by the airbag to protect an occupant.

A side airbag apparatus is widely known as an apparatus for protecting an occupant in a vehicle when receiving impact from a side as in a side collision impact. The side airbag apparatus includes an inflator and an airbag. The airbag is incorporated into a backrest of a vehicle seat in a compact folded fashion.

In the side airbag apparatus, when an impact is applied to a body side portion of the vehicle from a side, the inflator is activated and ejects gas into the airbag. The airbag, into which gas is ejected, is inflated and deployed frontward from the backrest in a narrow space between an occupant seated in the vehicle seat and the body side portion. The inflated airbag is interposed between the occupant and the body side portion intruding into the passenger compartment, thereby reducing a side impact applied to the occupant through the body side portion.

Generally, it is acknowledged that lumbar regions are superior to shoulders and thorax in resistance to impact applied to a side of the human body. For this reason, in the side airbag apparatus for protecting a wide region of the body of an occupant ranging from a shoulder to the lumbar regions, it is desired that the impact applied to the shoulder and the thorax by inflation and deployment of the airbag be less than the impact applied to the lumbar regions.

Accordingly, one type of side airbag apparatus has been introduced in which the interior of the airbag is divided into an upper chamber corresponding to the shoulder and the thorax of an occupant and a lower chamber corresponding to the lumbar regions of the occupant. Refer to Japanese Laid-Open Patent Publication Nos. 10-338099, 2005-47471, 2004-338698, 2006-15827 and the description of U.S. Patent Application Publication No. 2005/0218635A1.

In this type of side airbag apparatus, when the inflator is operated in response to a lateral impact, gas ejected from the inflator is guided into the lower chamber and then, flows into the upper chamber through a communication passage. Due to the gas flowing in this order, the lower chamber is inflated and deployed prior to inflation and deployment of the upper chamber. When the airbag is completely inflated and deployed, pressure distribution within the airbag is such that a section corresponding to the lower chamber is relatively hard and a section corresponding to the upper chamber is relatively soft. Since the pressure distribution within the airbag is suitable in consideration with difference among regions of the body of the occupant in resistance to impact, the occupant is effectively protected from the impact.

However, in the above-mentioned conventional side airbag apparatus, when a load is put on the seat cushion of the vehicle seat acts as an obstacle in the advancing direction of the airbag deployment, the following problem can occur. In the process when airbag deploys forward, the section of the airbag that corresponds to the lower chamber hardened due to a high internal pressure thereof hits and strongly pushes the obstacle, thereby having an effect on the obstacle.

### SUMMARY OF THE INVENTION

Accordingly, it is an objective of the present invention to provide a side airbag apparatus that, when an obstacle exits in the advancing direction of the airbag deployment, is capable of inflating and deploying the airbag without having any effect on the obstacle by strongly pushing the obstacle.

To achieve the foregoing objective, and in accordance with one aspect of the present invention, a side airbag apparatus is provided that includes an inflator which ejects gas in response to an impact from a side of a vehicle and an airbag which is in an accommodation form by being folded, stored in the vehicle, and inflated and deployed toward the front of the vehicle while being unfolded by gas ejected from the inflator. The airbag has a lumbar region protection chamber and a partition portion which forms a protection area protecting at least either a thorax or an abdominal region of the occupant. The lumbar region protection chamber is inflated at a higher internal pressure than the protection area. The partition portion is disposed in the internal space so as to be inclined downward toward the front of the vehicle when the airbag is deployed. The area corresponding to the lumbar region protection chamber of the airbag is folded along the inclination of the partition portion and the airbag is in an accommodation form in this state.

With the above-mentioned configuration, when an impact is applied to the vehicle from a side, the inflator of the side airbag apparatus ejects gas and feeds the gas into the internal space of the airbag in an accommodation form. The gas inflates each part of the airbag and deploys the airbag in a predetermined direction while unfolding the airbag. The area corresponding to the lumbar region protection chamber of the airbag is deployed in a different manner from the area corresponding to the protection area. Such a deployment is caused by the fact that the partition portion located between the lumbar region protection chamber and the protection area is inclined downward toward the front of the vehicle and that the area corresponding to the lumbar region protection chamber of the airbag is folded along the inclination of the partition portion.

Specifically, the area corresponding to the above-mentioned protection area is inflated substantially toward the front of the vehicle while being unfolded. On the other hand, the area corresponding to the lumbar region protection chamber is inflated at a higher internal pressure than the area corresponding to the protection area, and deployed downward and diagonally rearward, that is, in a direction substantially perpendicular to the inclined partition portion while being unfolded. Through the deployment, the area corresponding to the protection area is deployed toward the front of the vehicle while being pulled downward and diagonally rearward. The area of high internal pressure corresponding to the lumbar region protection chamber is inflated and deployed on a rear side in the vehicle of the area corresponding to the above-mentioned protection area.

Accordingly, the area corresponding to the lumbar region protection chamber of the airbag is inflated relatively hard beside the lumbar regions of the occupant. The area corresponding to the protection area of the airbag is deployed relatively softly beside at least either the thorax or the abdominal region of the occupant. By bringing the airbag into contact with each of the parts of the body of the occupant with the hardness in consideration of difference among the parts in resistance to impact, each part of the body of the occupant is effectively protected against the impact.

Even when an obstacle exists in an advancing direction of the deployment of the airbag and the inflated and deployed airbag contacts the obstacle, the obstacle is pushed by the relatively soft area corresponding to the protection area of a low internal pressure, not by the relatively hard area corresponding to the lumbar region protection chamber of a high internal pressure, until the airbag is completely inflated. Consequently, the effect of pushing the obstacle by the airbag is reduced.

### BRIEF DESCRIPTION OF DRAWINGS

FIG. 1 is a schematic side view of a vehicle seat to which a side airbag apparatus in accordance with one embodiment of the present invention is applied;

FIG. 2 is a schematic plan view showing positional relationship between the vehicle seat and a body side portion;

FIG. 3 is a partial broken side view of an airbag module of a deployed airbag;

FIG. 4(A) is a side view showing the state where the deployed airbag is folded inward along a folding line;

FIG. 4(B) is a partial enlarged cross-sectional view taken along a line 4B-4B in FIG. 4(A);

FIG. 5 is a side view showing the relationship between the airbag and folding lines (mountain fold lines and valley fold lines) set in a bellows-like folding;

FIGS. 6(A) and 6(B) are side views showing a process of folding the airbag;

FIG. 6(C) is a partial enlarged cross-sectional view taken along a line 6C-6C in FIG. 6(B);

FIG. 7 is a side view for describing operations of the embodiment of FIGS. 1 to 6(C); and

FIG. 8 is a partial enlarged side view of a main part in FIG. 7.

### DESCRIPTION OF THE PREFERRED EMBODIMENTS

Hereinafter, an embodiment of the present invention will be described with reference to drawings.

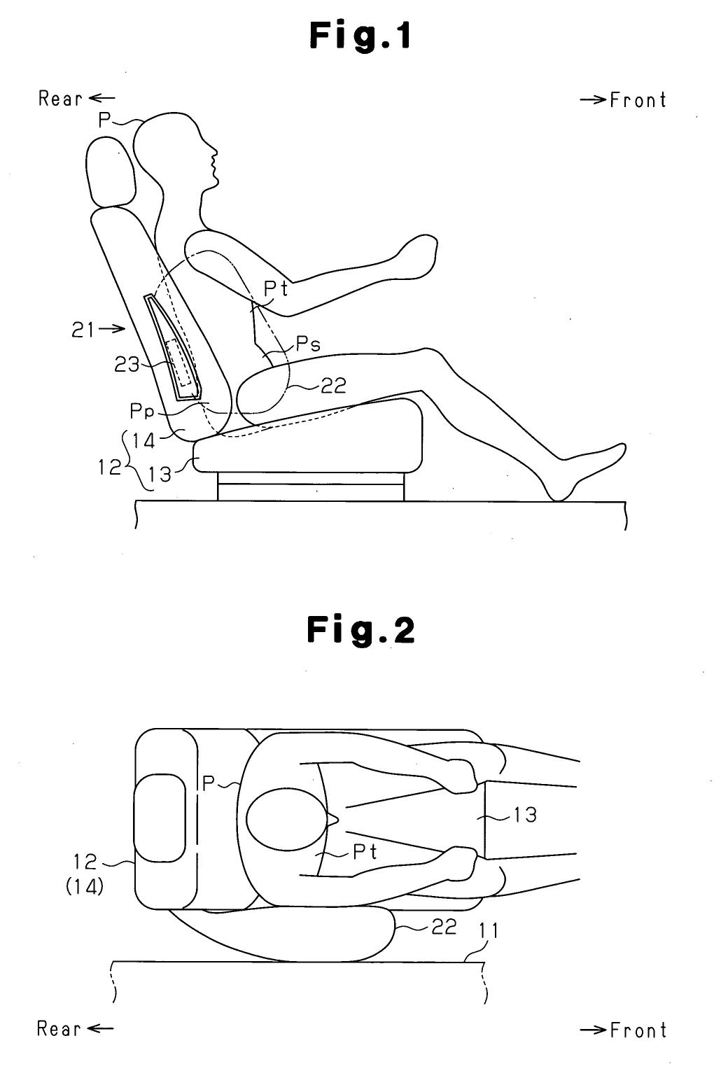

As shown in FIGS. 1 and 2, a vehicle seat 12 is disposed in the vicinity of a body side portion 11 in a vehicle. The body side portion 11 refers to a member disposed on a side of the vehicle and mainly corresponds to doors and pillars. For example, the body side portion 11 corresponding to a front seat consists of a front door and a center pillar (B pillar). The body side portion 11 corresponding to a rear seat consists of a rear part of a side door (rear door), a C pillar, a front part of a wheel well and a rear quarter panel.

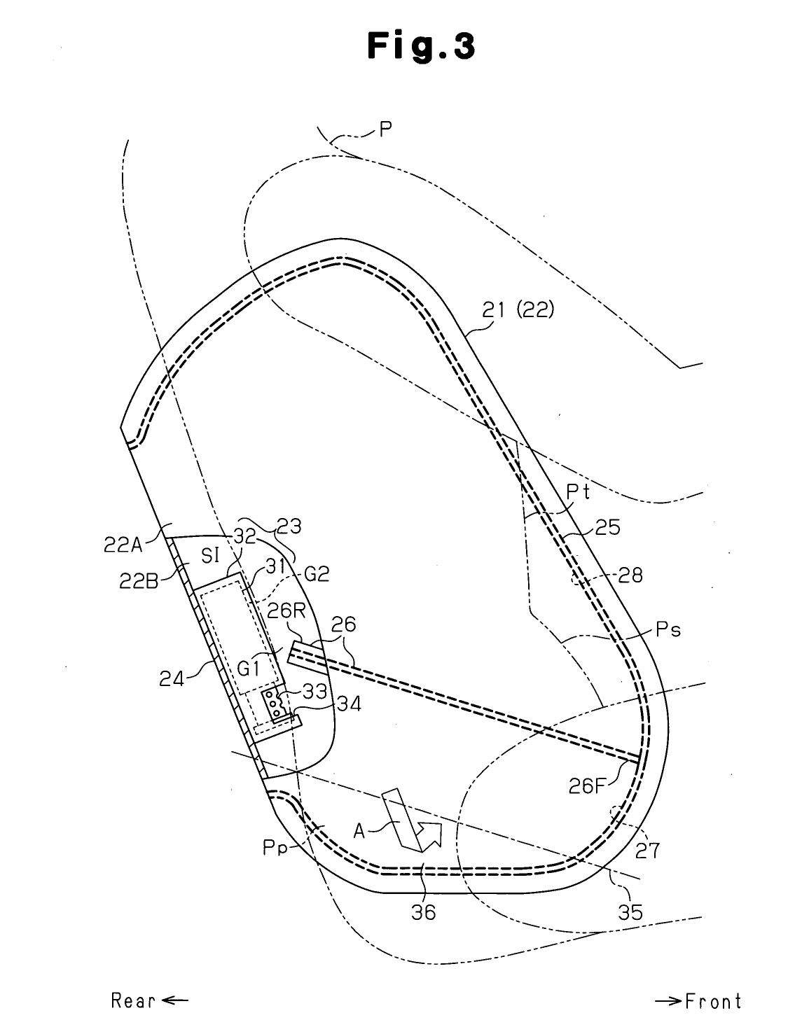

The vehicle seat 12 has a seat cushion (seat portion) 13 and a backrest 14. An airbag module 21 forming a main part of the side airbag apparatus is incorporated into a side of the backrest 14. The airbag module 21 includes an airbag 22 and an inflator assembly 23 as main components. Next, each of these components will be described. FIG. 3 schematically shows the airbag module 21 in the state where the airbag 22 is deployed without being filled with gas.

As shown in FIG. 3, the airbag 22 is made of a flexible and easily foldable material of high strength, for example, a single ground fabric sheet made of woven fabric formed by using polyester or polyamide yarn.

When the airbag 22 is produced, a sheet of ground fabric of predetermined shape is folded in half at the center thereof to form a pair of front and back stacked parts 22A, 22B of the same shape. Both of the stacked parts 22A, 22B are disposed in use such that a side 24 at the folding is located in the rear side in the vehicle. Both stacked parts 22A, 22B have sufficiently large dimension and shape to cover a wide region from lumbar regions Pp to a thorax Pt of a occupant P seated on the vehicle seat 12 when the airbag 22 is inflated and deployed (refer to FIGS. 1 and 2).

The pair of stacked parts 22A, 22B may be formed by stacking two ground fabric sheets upon each other. In this case, the ground fabric sheets constitute the stacked parts 22A, 22B, respectively.

The stacked parts 22A, 22B are connected to each other at a peripheral connecting part 25 provided on the peripheries of the stacked parts. In this embodiment, the peripheral connecting part 25 is formed by sewing the peripheries of the stacked parts 22A, 22B together by use of a sewing thread. The peripheral connecting part 25 may be formed by using means other than the sewing with sewing thread, for example, adhesive bonding with an adhesive agent.

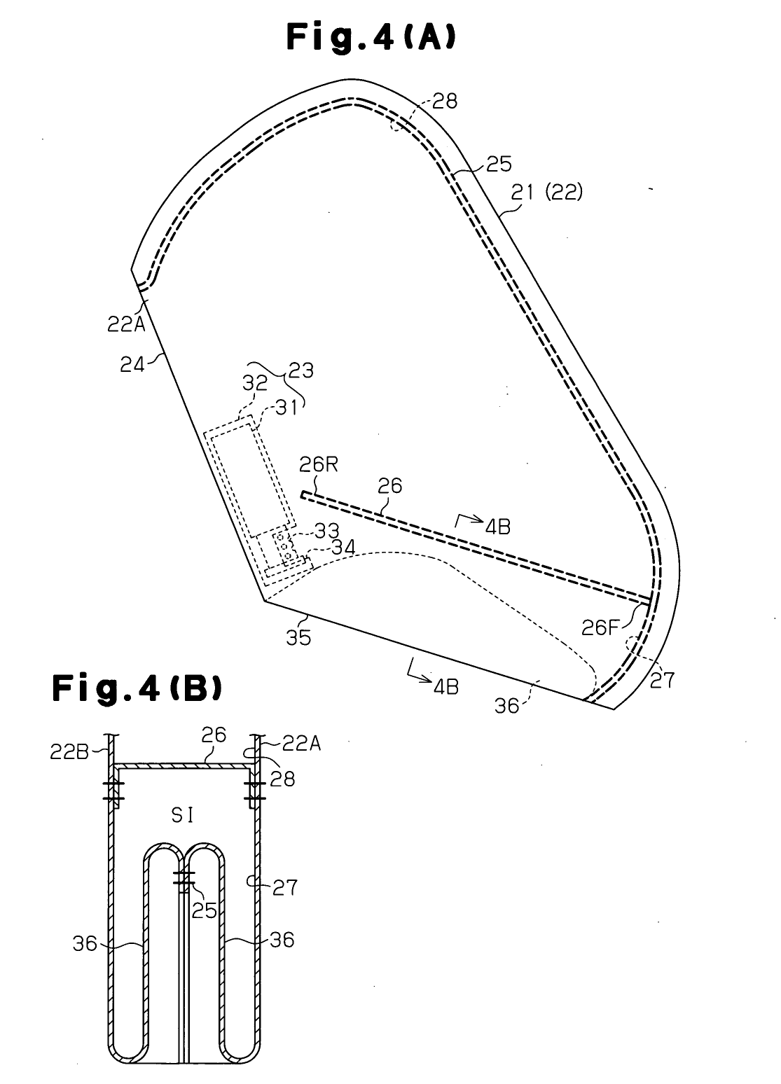

As shown in FIGS. 3 and 4(B), a tether 26 as a partition portion is provided in a lower portion of the deployed airbag 22. The tether 26 extends linearly, is formed of a band-like fabric such as a woven fabric like the airbag 22 and is inclined in an internal space SI of the airbag 22 so as to lower toward the front of the vehicle. Both edges of the tether 26 are sewed into the corresponding stacked parts 22A, 22B, respectively. By the sewing, the tether 26 extends between the stacked parts 22A, 22B. The tether 26 connects the stacked parts 22A, 22B to each other with a predetermined distance therebetween and restricts inflation in the vehicle width direction at the time of inflation and deployment of the airbag 22. The reason that the tether 26 is linearly disposed as described above is because this facilitates production (sewing) as compared to the other configuration, for example, the case where it is disposed in a curved fashion.

A front end 26F of the tether 26 is connected to a front lower part of the peripheral connecting part 25. A rear end 26R of the tether 26 is located at the point on the periphery (side 24) in the rear of the stacked parts 22A, 22B and at some distance from a middle part in the height direction toward the front.

The internal space SI of the airbag 22 is partitioned by the tether 26 into a chamber below the tether 26 and a chamber above the tether 26. When the airbag 22 is deployed, the lower chamber is located lateral to the lumbar regions Pp of the occupant P and protects the lumbar regions Pp. Thus, the lower chamber is referred to as “a lumbar region protection chamber 27”. When the airbag 22 is deployed, the upper chamber is located lateral to the thorax Pt and an abdominal region Ps of the occupant P and protects the thorax Pt and the abdominal region Ps. Thus, the upper chamber is referred to as “a thorax protection chamber 28”. The thorax protection chamber 28 corresponds to an adjacent chamber and protection area that are adjacent to the lumbar region protection chamber 27 across the tether (partition portion) 26 in the airbag 22.

As shown in FIG. 3, the inflator assembly 23 has an inflator 31 as a gas generator and a retainer 32 attached to the inflator 31. The inflator 31 is substantially shaped like a slender cylinder which extends in the substantially vertical direction and accommodates a gas generating agent (not shown) therein. This type of inflator 31 generates gas by combustion reaction of the gas generating agent. A plurality of gas outlets 33 for ejecting the generated gas outwards in the radial direction are provided at the lower end portion of the inflator 31.

As the inflator 31, in place of an inflator using the gas generating agent as described above, an inflator which ejects gas by breaking a partition wall of a high-pressure gas steel bottle filled with high-pressure gas with explosives or the like may be used.

The retainer 32 is a member which acts as a diffuser and serves to fix the inflator 31 in the backrest 14 together with the airbag 22 (refer to FIG. 1). The retainer 32 is substantially shaped like a slender pipe which extends in the vertical direction by bending a plate made of metal or the like. A window part 34 which allows the gas outlets 33 as a part of the inflator 31 to be exposed from the retainer 32 is provided on the front side of the lower end portion of the retainer 32. Gas fed from the gas outlets 33 is ejected substantially toward the front of the vehicle through the window part 34.

The inflator assembly 23 with such configuration is disposed slightly behind the tether 26 in the internal space SI of the airbag 22 and in the almost middle of the airbag 22 in the vertical direction. In such disposed state, the gas outlets 33 of the inflator 31 and the window part 34 of the retainer 32 are located within the lumbar region protection chamber 27.

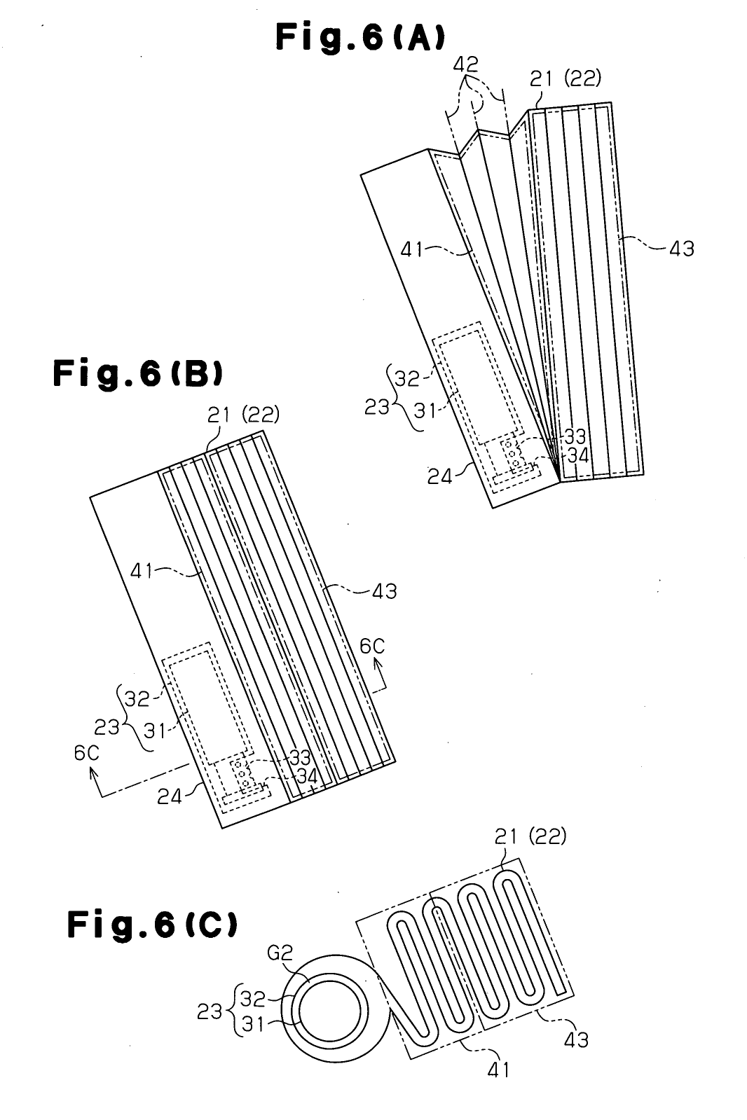

The rear end 26R of the tether 26 is slightly away from the retainer 32 forward in the airbag 22 to form a gap G1. The gap G1 constitutes a part of a connection part. A gap G2 between the inflator 31 and the retainer 32 in the inflator assembly 23 also constitutes a part of a connection part (refer to FIG. 6(C)). These connection parts connect the lumbar region protection chamber 27 to the thorax protection chamber 28. Part of gas in the lumbar region protection chamber 27 can flow into the thorax protection chamber 28 through the connection parts.

As described above, in the airbag 22, the connection parts are provided only in the rear portion of the tether 26, and no connection part is formed in front and middle portions. This is to ensure the internal pressure difference between the lumbar region protection chamber 27 and the thorax protection chamber 28.

In the side airbag apparatus, the airbag module 21 having the airbag 22 and the inflator assembly 23 as main components is made compact in an accommodation form as shown in FIGS. 6(B) and 6(C). This is to reliably store the airbag module 21 in a limited space in the backrest 14 on the outer side of the vehicle.

The deployed airbag 22 is made compact in an accommodation form as follows.

First, as shown in FIG. 3, in the airbag 22 deployed without being filled with gas, the area corresponding to the lumbar region protection chamber 27 is folded along an inclination of the tether 26. More particular, in the area corresponding to the lumbar region protection chamber 27 of the airbag 22, a part 36 away from the tether 26 downward is folded inward. Inward folding means one of modes of holding airbag 22 that the edge of the airbag 22 is located on the inner side of the other parts. In this embodiment, in performing inward folding, as shown by a dashed line in FIG. 3, a folding line 35 extending in parallel to the tether 26 is set below the tether 26 in the lumbar region protection chamber 27. As shown by arrow A, the part 36 below the folding line 35 in each of the stacked parts 22A, 22B of the airbag 22 is folded along the folding line 35 toward inner space between the tether 26 and the folding line 35. Through the folding, as shown in FIGS. 4(A) and 4(B), the lower part 36 enters the above-mentioned space, and is located above the folding line 35 and hidden.

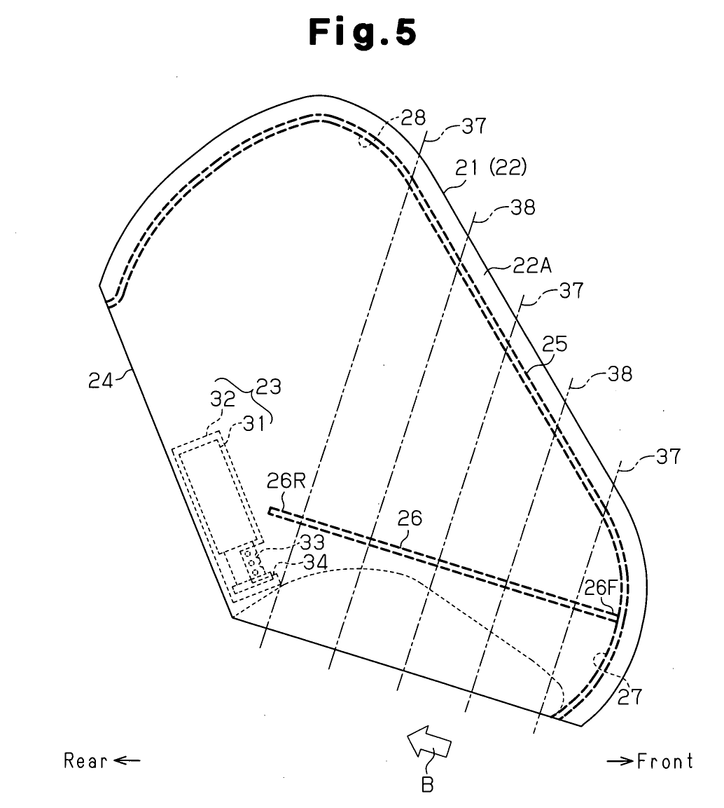

Next, the airbag 22 is folded like bellows. The bellows-like folding is one of modes of folding the airbag 22, in which the airbag 22 is folded back at regular intervals alternately in opposite directions. According to the bellows-like folding, as shown in FIG. 5, a plurality of mountain fold lines 37 linearly extending in the direction substantially perpendicular to the tether 26 and a plurality of valley fold lines 38 linearly extending in the direction substantially perpendicular to the tether 26 with respect to the airbag 22 are set. Since the tether 26 is linearly inclined toward the front of the vehicle, the mountain fold lines 37 and the valley fold lines 38 are linearly inclined so that upper parts thereof are closer to the front of the vehicle. The distance between the mountain fold line 37 and the valley fold line 38 corresponds to folding width of bellows-like folding. The airbag 22 is sequentially folded like bellows along the mountain fold lines 37 and the valley fold lines 38 by the above-mentioned folding width from the front of the vehicle toward the rear of the vehicle as shown by arrow B.

In this state, as shown in FIG. 6(A), an unfolded sectoral section 41 remains between a bellows-like folded section 43 and the inflator assembly 23 in the airbag 22. Thus, a folding lines 42 extending in the substantially vertical direction are set at the sectoral section 41. The folding lines 42 are set at three places of the section 41. However, the folding lines 42 may be set at other places. Alternatively, only one folding line 42 may be set. Then, by folding the sectoral section 41 like bellows along the folding lines 42, the airbag module 21 assumes “the shape in an accommodation form” as shown in FIGS. 6(B) and 6(C). In FIGS. 6(A) and 6(B), details of the airbag 22 is omitted or simplified. The details include the peripheral connecting part 25 and the tether 26.

The airbag module 21 in an accommodation form is inserted into a frame or the like in the backrest 14 (refer to FIGS. 1 and 2) by using a bolt (not shown) implanted in the retainer 32 and tightened and fixed with a nut.

The side airbag apparatus has an impact sensor and a control unit (not shown) in addition to the above-mentioned airbag module 21. The impact sensor is formed of an acceleration sensor or the like and provided at the body side portion 11 of the vehicle (refer to FIG. 2) or the other place. The impact sensor detects an impact applied to the body side portion 11 from the corresponding side. The control unit controls the operation of the inflator 31 on the basis of a detection signal sent from the impact sensor.

In this manner, the side airbag apparatus in this embodiment is configured. In this side airbag apparatus, when an impact exceeding a predetermined value is applied to the body side portion 11 of the vehicle and the impact sensor detects it, a drive current is output from the control unit to the inflator 31 on the basis of the detection signal. By heating based on the drive current, the gas generating agent in the inflator 31 generates high-temperature and high-pressure gas. This gas acts to eject from the plurality of gas outlets 33 located in the lumbar region protection chamber 27 outward in the radial direction. At this time, rear ones of the plurality of gas outlets 33 are closed with the retainer 32 and front ones of the plurality of gas outlets 33 are exposed through the window part 34. Thus, the gas is ejected from the front gas outlets 33 toward the front of the lumbar region protection chamber 27 through the window part 34.

The gas is fed to the chambers 27, 28, resulting in that areas corresponding to the chambers 27, 28 of the airbag 22 are inflated and deployed in a predetermined direction while being unfolded. The gas ejected through the gas outlets 33 is fed directly to the lumbar region protection chamber 27. The gas fed to the lumbar region protection chamber 27 is once fed to the thorax protection chamber 28 through the gap G1 (connection part) between the rear end 26R of the tether 26 and the retainer 32 shown in FIG. 3. Part of the gas ejected through the gas outlets 33 is fed to the thorax protection chamber 28 through the gap G2 (connection part) between the inflator 31 and the retainer 32.

The area corresponding to the lumbar region protection chamber 27 is different from the area corresponding to the thorax protection chamber 28 of the airbag 22 in the deployment mode. This is due to the fact that the tether 26, which partitions the airbag 22 into the chambers 27 and 28, is inclined downward toward the front of the vehicle and that the area corresponding to the lumbar region protection chamber 27 of the airbag 22 is folded along the inclination of the tether 26.

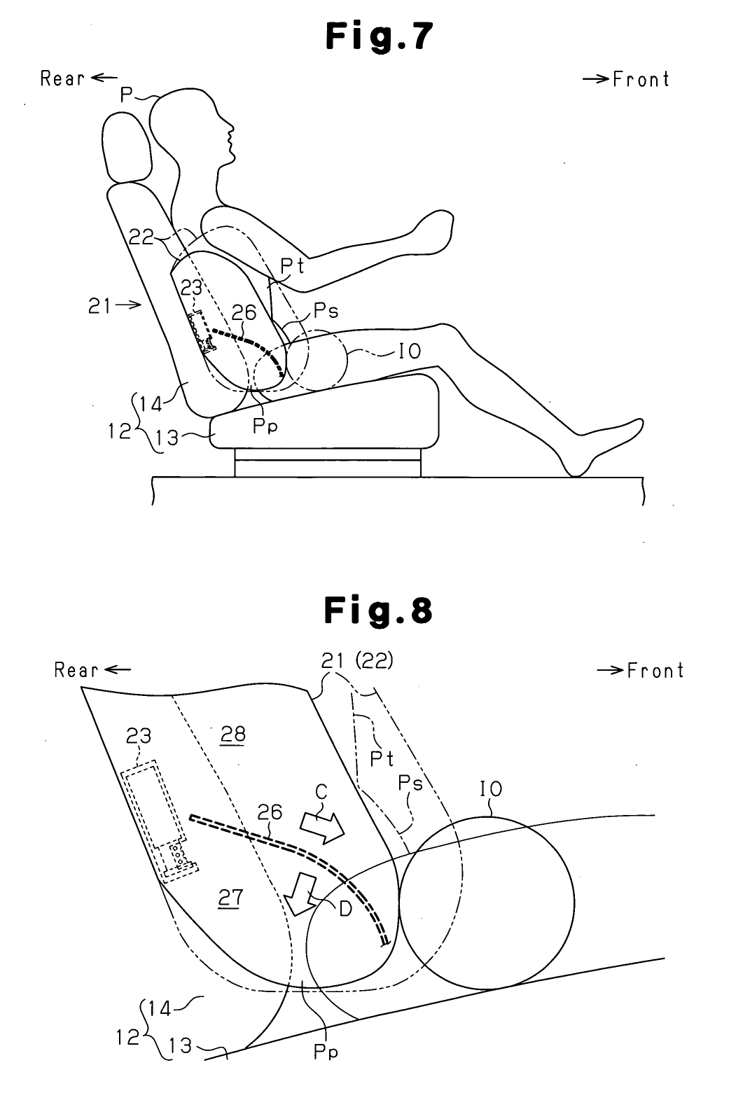

Specifically, the area corresponding to the thorax protection chamber 28 is inflated at a low internal pressure and deployed substantially toward the front of the vehicle while being unfolded. More accurately, in the thorax protection chamber 28, the mountain fold lines 37 and the valley fold lines 38 (refer to FIG. 5) are substantially perpendicular to the tether 26 inclined downward toward the front. Thus, as shown by arrow C in FIG. 8, the area corresponding to the thorax protection chamber 28 is deployed downward and diagonally to the front, that is, in the inclination direction of the tether 26 while being unfolded. Through the deployment, the lower end of the area corresponding to the thorax protection chamber 28 having a low internal pressure is located at an even lower place. In FIG. 8, the peripheral connecting part 25 is omitted (this also applies to FIG. 7).

On the other hand, the area corresponding to the lumbar region protection chamber 27 is inflated while being unfolded at higher internal pressure than the area corresponding to the thorax protection chamber 28 and deployed downward and diagonally to the rear in the direction substantially perpendicular to the inclined tether 26 as shown by arrow D in FIG. 8. Through the deployment, the area corresponding to the thorax protection chamber 28 is deployed toward the vehicle while being pulled down and diagonally to the rear as shown by a solid line in FIG. 8. The area of a high internal pressure corresponding to the lumbar region protection chamber 27 is inflated and deployed further backward of the vehicle as compared to the area of low internal pressure corresponding to the thorax protection chamber 28. In FIG. 8, an area represented by a chain double-dashed line with respect to the airbag 22 shows the completely inflated state of the airbag 22.

Accordingly, the area corresponding to the lumbar region protection chamber 27 of the airbag 22 is inflated relatively hard at a position lateral to the lumbar regions Pp of the occupant P. The area corresponding to the thorax protection chamber 28 of the airbag 22 is inflated relatively softly at a position lateral to the thorax Pt and the abdominal region Ps of the occupant P.

As shown in FIGS. 7 and 8, even when an obstacle IO exists in the advancing direction of the deployment of the airbag 22, for example, on the seat cushion 13 and the inflated and deployed airbag 22 contacts the obstacle IO, the obstacle IO is pushed by the relatively soft area of a low internal pressure (the area corresponding to the thorax protection chamber 28) of the airbag 22 prior to complete inflation. Until the airbag 22 is completely inflated, the obstacle IO is not pushed by the relatively hard area of a high internal pressure (the area corresponding to the lumbar region protection chamber 27).

Although the state where the airbag 22 is being inflated is shown in FIG. 8, even when the obstacle IO exists in the vicinity of the backrest 14 before inflation of the airbag 22, as described above, the obstacle IO is pushed by the area of a low internal pressure corresponding to the thorax protection chamber 28 until the airbag 22 is completely inflated.

In the case where the airbag 22 is folded according to a plurality of steps, when gas is fed to the internal space SI in the airbag 22 in an accommodation form from the inflator 31, the airbag 22 basically starts being unfolded in the order reverse to the folding order.

In this connection, in the present embodiment, the area corresponding to the lumbar region protection chamber 27 is folded along the inclination of the tether 26 prior to other folding, which corresponds to the above-mentioned case. Consequently, in the airbag 22 in an accommodation form (refer to FIG. 6(B)), the state in which the folded area in the sectoral section 41 (refer to FIG. 6(A)) and then, the area folded like bellows along the folding lines (the mountain fold lines 37 and the valley fold lines 38) perpendicular to the tether 26 (refer to FIGS. 6(A) and 5) are released by the gas generated by the inflator 31. Next, the area that is folded along the inclination of the tether 26 (refer to FIG. 5) starts to be unfolded. That is, the folded thorax protection chamber 28 of low internal pressure is unfolded and then, the folded lumbar region protection chamber 27 of high internal pressure is unfolded. By starting to unfold the folded parts in this order, the area corresponding to the thorax protection chamber 28 of low internal pressure interferes with the obstacle IO before the lumbar region protection chamber 27 of high internal pressure does.

Inward folding of the airbag 22 is easier to be unfolded than folding according to other modes. For example, in the case where the end part of the airbag 22 is folded on the outer side of other parts, after gas reaches the end part from the other parts, the end part is inflated, starting to unfold. However, in the case of inward folding, since the end part is located on the inner side of other parts, the gas acts on the end part early and the end part is pushed by the other parts. Thus, the airbag 22 is unfolded in an early stage. In this embodiment, the part folded inward along the folding line 35 parallel to the inclined tether 26 is rapidly deployed downward and diagonally to the rear.

The lumbar region protection chamber 27 is connected to the thorax protection chamber 28 in the rear of the tether 26, but is not connected in the other places, for example, in the front and middle parts of the tether 26. With such configuration, no gas in the lumbar region protection chamber 27 leaks out to the adjacent thorax protection chamber 28 through the places other than the rear of the tether 26. Consequently, it is prevented that the contact portion of the thorax protection chamber 28 with the obstacle IO is hardened due to inflow of gas.

The following effects can be obtained according to this embodiment described in detail.

(1) The tether 26 is inclined downward toward the front of the vehicle and the area corresponding to the lumbar region protection chamber 27 of the airbag 22 is folded along the inclination of the tether 26. Thus, it is possible to inflate the area corresponding to the lumbar region protection chamber 27 of the airbag 22 beside the lumbar regions Pp of the occupant P to be relatively hard and to inflate the area corresponding to the thorax protection chamber 28 beside the thorax Pt and the abdominal region Ps of the occupant P to be relatively soft. By bringing the airbag 22 into contact with each of the parts of the occupant P with the hardness in consideration of difference among the parts in resistance to impact, each part of the occupant P can be effectively protected against impact.

Even when the obstacle IO exists in the advancing direction of the deployment of the airbag 22, the area corresponding to the thorax protection chamber 28 of a low internal pressure can be brought into contact with the obstacle IO until the airbag 22 is completely inflated. The airbag 22 can be inflated and deployed without strongly pushing and having effect on the obstacle IO, thereby improving the deployment performance of the airbag 22.

(2) The area corresponding to the lumbar region protection chamber 27 is folded along the inclination prior to other folding of the airbag 22 (for example, bellows-like folding). For this reason, by the gas generated from the inflator 31, the airbag 22 in an accommodation form can bring the relatively soft area of a low internal pressure corresponding to the thorax protection chamber 28 into contact with the obstacle IO before bringing the relatively hard area of high internal pressure corresponding to the lumbar region protection chamber 27. As a result, the deployment performance of the airbag 22 is further improved.

(3) Inward folding is employed as the folding mode along the inclination of the tether 26, and the part away from the tether 26 downward in the area corresponding to the lumbar region protection chamber 27 of the airbag 22 is folded on the inner side of the part in the vicinity of the tether 26. For this reason, the area corresponding to the lumbar region protection chamber 27 is rapidly deployed downward and diagonally to the rear.

(4) The tether 26 is linearly disposed in the internal space SI of the airbag 22. For this reason, the tether 26 is easier to be manufactured than a case where the tether 26 is disposed differently.

(5) The connection part connecting the lumbar region protection chamber 27 to the thorax protection chambers 28 is not provided any place other than the place in the rear of the tether 26. For this reason, it is prevented that the contact portion of the thorax protection chamber 28 against the obstacle IO is hardened by inflow of the gas from the lumbar region protection chamber 27 into the thorax protection chamber 28, and thus, the effect of the contact on the obstacle IO is reduced.

(6) The airbag 22 is folded like bellows along the folding lines (mountain fold lines 37, valley fold line 38) substantially perpendicular to the tether 26. For this reason, the airbag 22 in an accommodation form is deployed downward and diagonally to the front. This is effective in bringing the area of low internal pressure corresponding to the thorax protection chamber 28 of the airbag 22 into contact with the obstacle IO.

The present invention can be realized by another embodiment.

The shape of the partition portion (tether 26) may be changed as long as the condition that “it is inclined downward toward the front” is satisfied. Thus, the partition portion (tether 26) is not necessarily linear and may be slightly curved so as to swell upward or to be fallen downward. The partition portion (tether 26) may be shaped stepwise.

When the internal space SI of the airbag 22 is partitioned into two chambers by the partition portion (tether 26), one chamber needs to be the lumbar region protection chamber 27. The other chamber may be a chamber for protecting an area other than the thorax Pt and the abdominal region Ps of the occupant P, for example, shoulder and head, or a chamber for protecting either the thorax Pt or the abdominal region Ps.

The internal space SI of the airbag 22 may be partitioned into three or more chambers. In this case, similarly, one chamber is set as the lumbar region protection chamber 27. Remaining chambers may be chambers for protecting a plurality of areas other than the lumbar regions Pp. Target areas include the abdominal region Ps, the thorax Pt, shoulder and head.

The present invention may be also applied to an airbag apparatus in which an area located in the vicinity of the side of either the thorax Pt or the abdominal region Ps of the occupant P when the airbag 22 is completely inflated is set as a non-inflated part.

In place of the tether 26, a seam may be used as the partition portion. In this case, both the stacked parts 22A, 22B are sewed together by a sewing yarn. The part sewed by the sewing yarn corresponds to the seam. Like the tether 26, the front end of the seam is desirably connected to the front lower part of the peripheral connecting part 25.

The folding line 35 is not necessarily parallel to the tether 26 and may be inclined relative to the tether 26. In this case, from the viewpoint that the part folded inward is deployed toward the rear of the vehicle, it is desired that the folding line 35 be inclined so that the angle of the folding line with respect to the horizontal plane is large.

Like the area corresponding to the lumbar region protection chamber 27, the area corresponding to the thorax protection chamber 28 may be folded inward. In this case, when the former inward folding has opposite inclination to the latter inward folding, a force applied downward and diagonally to the rear occurs at the time of deployment and thus, the deployment performance of the thorax protection chamber 28 is improved.

1. A side airbag apparatus which inflates and deploys an airbag when an impact is applied to a vehicle from a side, and reduces the impact by the airbag to protect the occupant comprising:
an inflator which ejects gas in response to an impact from a side of a vehicle,
wherein the airbag is shaped in an accommodation form by being folded, stored in the vehicle, and inflated and deployed toward the front of the vehicle while being unfolded by gas ejected from the inflator,
wherein the airbag has a lumbar region protection chamber inflated beside lumbar regions of the occupant and a partition portion which forms a protection area, which is adjacent to the lumbar region protection chamber, the protection area protecting at least either a thorax or abdominal region of the occupant, and the lumbar region protection chamber is inflated at a higher internal pressure than the protection area,
wherein the partition portion is disposed in the internal space so as to be inclined downward toward the front of the vehicle when the airbag is deployed, and
wherein an area corresponding to the lumbar region protection chamber of the airbag is folded along the inclination of the partition portion, and the airbag is shaped in the accommodation form in this state.

2. The side airbag apparatus according to claim 1, wherein the area corresponding to the lumbar region protection chamber is folded along the inclination prior to folding of the other parts.

3. The side airbag apparatus according to claim 1, wherein folding along the inclination of the partition portion is performed by folding, toward the inner side in the vicinity of the partition portion, a part of the area corresponding to the lumbar region protection chamber of the airbag that is away from the partition portion downward.

4. The side airbag apparatus according to claim 1, wherein the partition portion is linearly disposed.

5. The side airbag apparatus according to claim 1, wherein the protection area includes an adjacent chamber formed next to the lumbar region protection chamber in the internal space with the partition portion in between, and
wherein the airbag has a connection part for connecting the lumbar region protection chamber to the adjacent chamber.

6. The side airbag apparatus according to claim 1, wherein the airbag is folded along a folding line substantially perpendicular to the partition portion.
